(19) United States
(12) Patent Application Publication
(10) Pub. No.: US 2015/0247719 A1
(43) Pub. Date: Sep. 3, 2015

(54) POSITION SENSING SYSTEM FOR INTELLIGENT VEHICLE GUIDANCE

(71) Applicant: TOMORROW'S TRANSPORTATION TODAY, LAFAYETTE, CA (US)

(72) Inventors: JIHUA HUANG, RICHMOND, CA (US); HAN-SHUE TAN, CONCORD, CA (US); WEI-BIN ZHANG, LAFAYETTE, CA (US)

(73) Assignee: TOMORROW'S TRANSPORTATION TODAY, LAFAYETTE, CA (US)

(21) Appl. No.: 14/195,713

(22) Filed: Mar. 3, 2014

(51) Int. Cl. G01B 7/14; B62D 15/02

(52) U.S. Cl. CPC G01B 7/14; B62D 15/021; B62D 15/025

(57) ABSTRACT

A method for determining a position deviation of an object with respect to a magnetic marker. The method senses at least two axial field strength components of the magnetic field emitted from the magnetic marker with each of at least two magnetic field sensors mounted on the object. For each axial direction, the method computes a difference in the axial field strength components sensed by the two sensors. The method then determines the position deviation of the object from the magnetic marker as a function of the two differences (i.e., one difference for each axial direction). The method can be used by an intelligent lateral control system to provide lateral deviation of a mobile object, such as a vehicle, from a desired path, and the intelligent lateral control determines and applies the desired steering control to the mobile object so as to guide it along a desired path automatically.

### BACKGROUND

1. Technical Field

The present invention relates to a position detection method and system that determines its position with respect to magnetic markers. When installed on a vehicle, the position detection system can determine the vehicle's position with respect to a traffic lane it is traveling in. More specifically, magnetic markers are installed in the traffic lane to provide a road reference. As the vehicle travels along the lane, the position detection system senses magnetic field strength and estimates the vehicle's position with respect to the traffic lane. The vehicle position information can further be used by an intelligent guidance system to automatically guide the vehicle along the traffic lane.

2. Related Art

The development of a robust, reliable, and accurate sensing system is central to the automatic control of mobile vehicles. For vehicle lateral control, the typical sensing technologies include vision based, DGPS based, and road reference based methods. The vision based system uses a camera to identify the lane as well as the vehicle's lateral position in the lane. However, vision-based systems have difficulties in poor visibility conditions such as fog, rain, and snow. The DGPS based system estimates the vehicle's location on earth using its distances to at least four satellites based on the triangulation principle and then estimates the vehicle's position in the lane by mapping the vehicle location in a digital map. However, the DGPS based systems may suffer from signal blockage and multipath when the vehicle travels by tall buildings, tunnels, and under dense trees. The road reference based systems consist of roadway references, such as induction wires, radar-reflective tape, and magnetic markers, which are installed along the roadway and on-board sensing system that senses the vehicle's position with respect to the road reference. In particular, the road reference systems with magnetic markers have the advantages of being highly reliable and insensitive to weather conditions.

In the road reference systems with magnetic markers, discrete magnetic markers are installed in the roadway, generating local magnetic fields. Magnetic field sensors, e.g., magnetometers, are installed on the vehicle and measure the magnetic field strength as the vehicle travels. The measurements of the magnetic field strength can be used to determine the position between the magnetic field sensors and the magnetic markers and thereby estimate the vehicle's position with respect to the roadway. Moreover, each magnetic marker can be installed with either north polarity or south polarity facing upward to represent binary information (i.e., 1 or 0), and the sequence of the polarity forms codes that can be used to infer roadway information such as road curvature and mile posts.

One main challenge in the position estimation is how to effectively remove or minimize the effects of noises or disturbances so as to achieve accurate and reliable position estimates. For the magnetic sensing system, the noise mainly comes from three sources: earth magnetic field, alternating current (AC) generated disturbances, and electrical noise. Generally the largest source of external noise (about 300 to 600 mGauss) comes from the earth's permanent magnetic field, which varies in magnitude according to location. In addition to the slow trend components, local anomalies may arise due to the presence of structural supports, reinforcing bars, and the vehicle itself A second major source of magnetic noise comes from the alternating electric fields generated by the various motors operating in the sensor's vicinity, such as alternators, compressor, pump, fan, and actuators. The effects vary according to motor rotation and diminish as the cube of the distance away from the sensor. Finally, another possible noise source arises directly from the electric fields themselves. The noise may be the result of voltage fluctuations in the sensors and/or the processor.

In addition to the noise in the sensor measurements, the position estimation will also need to deal with the nonlinearity inherent in the magnetic field of a magnetic marker. For explanation purposes, the magnetic field of a magnetic marker typically can be mathematically modeled using a dipole model, where the magnetic field strength at a location P(x,y,z) with respect to the magnetic marker is given by B=(μ₀M/4πr⁵){3xzi+3yzj+(2z²−x²−y²)k}, where r is the distance between P and the magnetic marker, μ₀ is a constant representing the permeability of free space, and M is the magnetic moment of the marker and varies according to maker material. xi corresponds to the direction of travel, yj corresponds to the lateral deviation, and zk is the height relative to the marker's center. As it is complicated to estimate the lateral deviation by using the dipole model directly due to its nonlinear nature, an approximation is typically used in the estimation. The approximation itself becomes another source of errors and the estimation needs to ensure the assumptions associated with the approximation are met in the processing.

Several methods have been proposed for the position estimation based on measurements of the magnetic field strength. In one prior art method, a magnetic field sensor that consists of a pair of orthogonally oriented probes is installed in the center line of the vehicle where the two probes measure the magnetic field strength in the lateral and vertical directions, respectively. This position estimation then involves earth identification and peak mapping. The earth field strength is identified when the sensor is in the middle of two magnetic markers, assuming that the sensor measurements consist entirely of earth field strength when the magnetic field sensor is halfway between two markers. The peak time is defined as the time the magnetic field sensor is crossing a magnetic marker; that is, the sensor is at a location where the longitudinal distance between the sensor and the marker is 0. The peak time is identified as the time the vertical measurement reaches its maximum value. The position estimation then removes the estimated earth field from the measurements at the peak time, and maps the resulting lateral and vertical values to a pre-defined table to determine the lateral distance between the magnetic field sensor and the marker. Accordingly, the vehicle lateral position related to the marker can be estimated since the installation location of the sensor on the vehicle is known.

The aforementioned prior art has several drawbacks. First, it is computational intensive because it requires identification of the peak time as well as when the magnetic field sensor is in the middle of two markers. Second, to ensure the accurate estimate of earth field, the magnetic markers need to be spaced with adequate spacing (typically greater than 0.8 m) so that the sensor measurements consist mostly of earth field when it is in the middle of two markers. Third, the position is only estimated using measurements when the magnetic field sensor is crossing a marker, thus yielding one position estimate per marker. This is undesirable especially when the vehicle is moving very slowly or negotiating a very tight curve where the lateral position in the lane is changing fast. In addition, any errors in the earth field estimation or the peak time detection contribute to the errors in the position estimation.

In addition, the aforementioned prior art employs one sensor installed in the center line of the vehicle. However, to achieve an adequate signal-to-noise ratio for position estimation, the effective sensing range of a magnetic field sensor is typically less than 50 cm, which is not sufficient to meet the needs of lateral control for various maneuver types such as negotiating tight curves.

To extend the sensing range, another prior art method employs multiple magnetic field sensors, computes a ratio of the sensed axial field strength components, and determines the position offset from the magnetic reference as a function of the ratio. For example, refer to the two sensors that are closest to the magnet marker as the left sensor and the right sensor. The ratio can be computed as (Byleft+Byright)/(Byleft−Byright), where Byleft and Byright are the lateral field strength measurements from the left sensor and the right sensor, respectively. Depending on the probes involved in the magnetic field sensor (i.e., single probe, two probes, or three probes), the ratio can be computed differently. For example, if each magnetic field sensor consists of two probes in the lateral and vertical directions, the ratio can be computed as (Byright*Bzright)/(Byleft*Bzright−Byright*Bzleft), where Bzleft and Bzright are the vertical field strength measurements from the left and right sensors, respectively. The lateral position is then estimated as a function of this ratio, for example, from a look-up table.

The advantage of this prior art method is that by using multiple sensors the overall sensor range is extended. However, this prior art method is weak in rejecting noises and disturbance. First, the largest noise source, earth magnetic field, is not considered in this method. Even if we assume the left sensor and right sensor are close enough to have exactly same earth field strength, the earth field is removed in the denominator of the ratio but it is either doubled (in case of the sum operation) or multiplied (in case of the multiply operation) in the numerator of the ratio. Second, this ratio-based method also suffers from singularity problem which renders it very sensitive to noise. For example, in the case when the ratio is (Byleft+Byright)/(Byleft−Byright), the denominator (Byleft−Byright) is approximately zero when the marker is right in the middle of the two sensors. The ratio and therefore the position estimate based on the ratio are then very sensitive to the noise in Byleft and Byright. Similarly, in the case when the ratio is (Byleft*Bxright)/(Bxleft*Byright), the denominator is approximately zero when the marker is right under the right sensor; thus, the ratio and the position estimate are very sensitive to noise. In short, this ratio-based method does not handle noise and disturbances effectively and therefore is lacking in accuracy and robustness.

It is therefore desirable to have a position detection method and apparatus that is capable of providing accurate position estimates by sensing the magnetic field emitted from a magnetic marker with an adequate sensing range and robust to various noise and disturbances. It is also desirable to allow variable spacing between magnetic markers along a path as well as allowing multiple position estimates per marker.

### SUMMARY

In accordance with one embodiment of the present invention, a method for determining a position deviation of an object with respect to a magnetic marker is provided. With at least two magnetic field sensors mounted on the object and each magnetic field sensor comprising at least two probes that are set in different axial directions, the method senses at least two axial field strength components of the magnetic field emitted from the magnetic marker with each of the magnetic field sensors. For each axial direction, the method computes a difference in the axial field strength component sensed by the two sensors. The method then determines the position deviation of the object from the magnetic marker as a function of the two differences (i.e., one difference for each axial direction).

In another embodiment, the magnetic field sensors are aligned in the lateral direction of the object, and the two axial field strength components sensed by each sensor are in the lateral direction and the vertical direction of the object, respectively. With this alignment, the position deviation determined by the method is a deviation in the lateral direction of the object.

In another embodiment, the method determines the position deviation of the object from the magnetic marker by mapping the two differences into a pre-defined map that associates the two differences with the position deviation. For example, the pre-defined map consists of multiple relationships between the two differences in the two axial field strength components, and each relationship corresponds to a specific pre-defined position deviation. Mapping of the two differences includes (1) identifying two relationships the computed differences fall in between, (2) obtaining the two pre-defined lateral deviations corresponding to the two identified relationships, and (3) computing two distances from the differences to the two identified relationships. The method then determines the position deviation of the object by interpolating between the two pre-defined lateral deviations with the two distances.

The magnetic field sensors employed by the method may be digital two-axis magnetic field sensors that provide the magnetic field strength measurements in digital form. (A two-axis magnetic field sensor consists of two probes set in two different (typically orthogonal) directions and each probe measures magnetic field strength in one direction.) These magnetic field sensors output the field strength measurements to a digital processor, which processes the sensor measurements to provide the position deviation. Alternatively, analog two-axis magnetic field sensors may be employed to provide the magnetic field strength measurements in analog form to analog-to-digital converters. The analog-to-digital converters convert the measurements from analog form to digital form and then output them to the digital processor for the estimation of the position deviation.

In a further embodiment, more than two magnetic field sensors are mounted on the object, each providing measurements of at least two axial field strength components of the magnetic field. The method then selects two strongest sensors among all magnetic field sensors, computes the differences in the field strength components sensed by the two strongest sensors, and determines the position deviation of the object based on those two differences.

In another embodiment, the two axial field strength components are in the lateral and the vertical direction of the object, and the method selects the two strongest sensors in two steps. In step 1, a first strongest sensor is identified to be the magnetic field sensor whose vertical field strength measurement has the largest magnitude among all magnetic field sensors. Then in step 2, the method compares the vertical field strength measurements from the two magnetic field sensors adjacent to the first strongest sensor and chooses the one whose vertical field strength is larger as the second strongest sensor.

In another embodiment, a magnetic field sensor that consists of three probes is mounted on the object to sense three axial field strength components of the magnetic field emitted from the magnetic marker. The method computes the second-order Euclidean norm of two axial field strength components and determines a Euclidean distance from the object to the magnetic marker in a plane defined by those two axle space based on the Euclidean norm and the third axial field strength component. The method then computes the position deviation of the object from the magnetic marker as a function of the Euclidean distance, the Euclidean norm, and the first two axial field components. In a specific embodiment, the three axial field strength components are in the lateral, the longitudinal, and the vertical directions of the object, the first two axial field strength component are in the lateral and the longitudinal directions, the third axial field strength component is in the vertical direction, and the position deviation of the object is a lateral deviation from the magnetic marker.

In a further embodiment, the method comprises a pre-defined map, which associates the Euclidean norm and the third axial field strength component with the Euclidean distance. Accordingly, the Euclidean distance is determined by mapping the Euclidean norm and the third axial field strength component into the pre-defined map. As an example, the pre-defined map may consist of multiple relationships between the Euclidean norm and the third axial field strength component, where each relationship corresponds to a pre-defined Euclidean distance. The mapping then involves identifying two relationships the Euclidean norm and the measured third axial field strength component fall in between, obtaining two pre-defined Euclidean distances corresponding to the two identified relationships, computing two distances from the Euclidean norm and the third axial field strength component to the two relationships. The method then determines the position deviation by interpolating between the two pre-defined Euclidean distance using the two distances.

Furthermore, an intelligent lateral control system employing the disclosed method to automatically guide a mobile object along a path embedded with magnetic markers is also provided. One embodiment of this intelligent lateral control system consists of a position sensing unit to provide at least one position deviation of the mobile object with respect to the magnetic markers by using the differences in measurements of two magnetic field sensors, a lateral control unit to determine a desired steering angle based on the position deviation from the position sensing unit; and a steering actuator unit to turn the steering wheel based on the desired steering angle. In one embodiment, the intelligent lateral control system further consists of a human machine interface unit to receive commands from an operator, provide the commands from the operator to the lateral control unit, receive system information from the lateral control unit, and display the received system information to the operator.

In a further embodiment, the position sensing unit consists of at least one position detection apparatus. The position detection apparatus further consists of at least two magnetic field sensors, each sensing at least two axial field strength components of a magnetic field emitted from a magnetic marker, and a processor receiving magnetic field strength measurements from each magnetic field sensor and determining a position deviation using differences in field strength measurements from the two magnetic field sensors. For example, the processor may determine the position deviation by identifying the two strongest sensors among the magnetic field sensors, compute differences of the field strength measurements from these two strongest sensors, and then determine a position deviation of the said object as a function of the said differences.

In one embodiment, the position sensing unit consists of at least one position detection apparatus, which consists of at least one magnetic field sensor sensing three axial field strength components of the magnetic field emitted from a magnetic marker along the path. The position detection apparatus further computes a second-order Euclidean norm of the two axial field components in the lateral and longitudinal directions, determines a Euclidean distance from the object to the magnetic marker in a plane defined by the lateral and longitudinal direction based on the Euclidean norm and the third axial field strength component, and then computes the lateral deviation of the object from the magnetic marker as a function of the Euclidean distance, the Euclidean norm, and the first two axial field components.

In another embodiment, the position sensing unit provides at least two position deviations of the mobile object with respect to the magnetic markers. The lateral control unit computes a relative angle of the mobile object with respect to the path based on the at least two position deviations and determines the desired steering angle based on the position deviations and the relative angle.

### BRIEF DESCRIPTION OF THE DRAWINGS

Further details of the present invention are explained with the help of the attached drawings in which:

FIG. 1 shows a first embodiment of a position detection apparatus installed on a vehicle, which is capable of detecting the lateral position of the vehicle with respect to a magnetic marker installed in the roadway.

FIG. 2 shows a top view of the first embodiment of the position detection apparatus installed on the vehicle.

FIG. 3 is a block diagram of one embodiment of the position detection apparatus.

FIG. 4 illustrates a two-axis magnetic field sensor that consists of a pair of orthogonally oriented probes.

FIG. 5 illustrates the magnetic field strength of a magnet marker, and the corresponding measurements of magnetic field sensors in the position detection apparatus.

FIG. 6 is a map showing relationships of the differences in the lateral and vertical measurements of two magnetic field sensors on the left and right side of a magnetic marker.

FIG. 7 is a map showing relationships of lateral and vertical measurements (with earth field removed) of a magnetic field sensor close to a magnetic marker.

FIG. 8 is a map showing relationships of the differences in the lateral and vertical measurements of two magnetic field sensors for cases when the magnetic marker is in between the two magnetic field sensors and when the magnetic marker is on one side of the two magnetic field sensors.

FIG. 9 is a flowchart showing the process involved in one embodiment of the position detection apparatus for determining the lateral deviation from the apparatus (hence the object where the apparatus is installed on) to the magnetic marker.

FIG. 10 is a flowchart showing the process involved in another embodiment of the position detection apparatus for determining the lateral deviation from the apparatus (hence the object where the apparatus is installed on) to the magnetic marker.

FIG. 11 is a block diagram of another embodiment of the position detection apparatus.

FIG. 12 illustrates another embodiment of a method and apparatus for detecting the position of a mobile object on which the apparatus is installed, in which each magnetic field sensor includes three orthogonally oriented probes measuring the magnetic field strength in the vertical, lateral, and longitudinal directions.

FIG. 13 is a flowchart showing the process involved in one embodiment of the position detection apparatus for determining the lateral deviation from the apparatus (hence the object where the apparatus is installed on) to the magnetic marker using magnetic field strength measurements in the vertical, lateral, and longitudinal direction.

FIG. 14 is a block diagram of an embodiment of an intelligent lateral control system using the position detection method and apparatus.

FIG. 15 illustrates the locations of the two position detection apparatuses used in one embodiment of the intelligent lateral control system.

### DETAILED DESCRIPTION

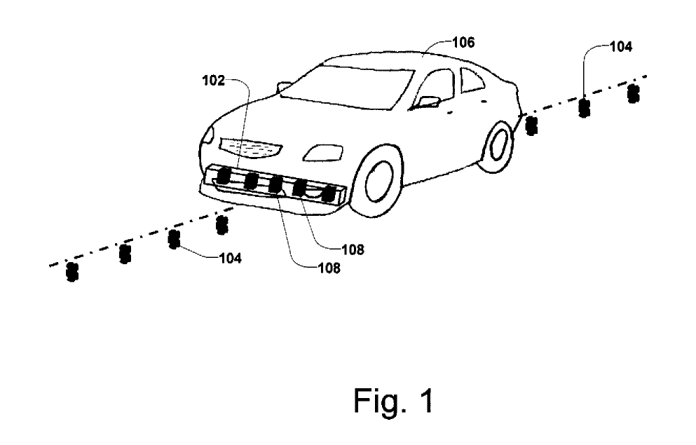

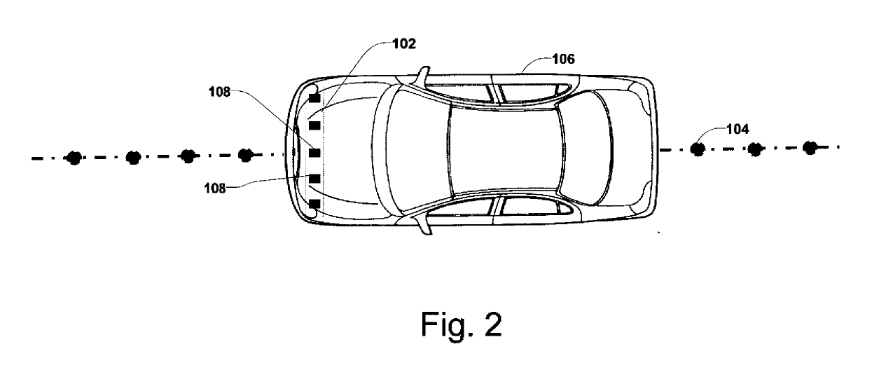

FIG. 1 is an isometric view and FIG. 2 is a top view of a mobile object 106 including a first embodiment of a position detection apparatus 102 that is capable of determining a position offset between the position detection apparatus 102 and magnetic markers 104 installed along a roadway along which the object 106 is traveling. By detecting the position offset from the magnetic markers 104, the position detection apparatus 102 provides a lateral deviation of the mobile object 106 from the roadway.

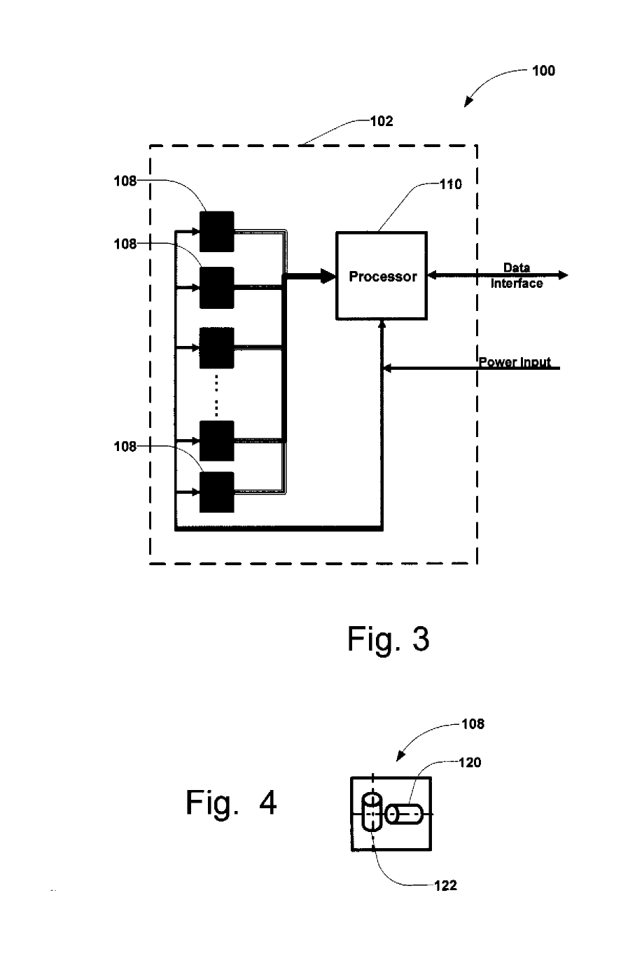

FIG. 3 is a block diagram 100 showing the position detecting apparatus 102 separated from the object 106. In this embodiment, the position detection apparatus 102 includes at least two magnetic field sensors 108 and a processor 110. Five magnetic field sensors 108 are shown in FIG. 1, FIG. 2, and FIG. 3 only for illustration purposes. The sensors 108 may be integrated into the same enclosure or be separated packaged into separate units.

Each sensor 108 consists of at least two probes, each measuring one axial field strength of the magnetic field of a magnetic marker 104. FIG. 4 illustrates such a two-axis magnetic field sensor 108. The two probes 120 and 122 are positioned in two different directions and typically the two directions are preferred to be orthogonal as shown in FIG. 4.

The processor 110 could be an embedded processor, such as ARM-based microprocessors, or an industrial PC, or an application specific integrated circuit (ASIC). The processor 110 may be integrated into the same enclosure that contains the sensors 108 or be a separate unit located away from the sensors 108. The processor 110 determines the lateral deviation of the position detection apparatus 102 (equivalently the mobile object 106) from the magnetic markers 104 based on the measurements from the sensors 108. More specifically, the processor 110 identifies the two sensors 108 on both sides of the magnet marker 104 and determines the lateral deviation based on the differences between the measurements of these two sensors 108.

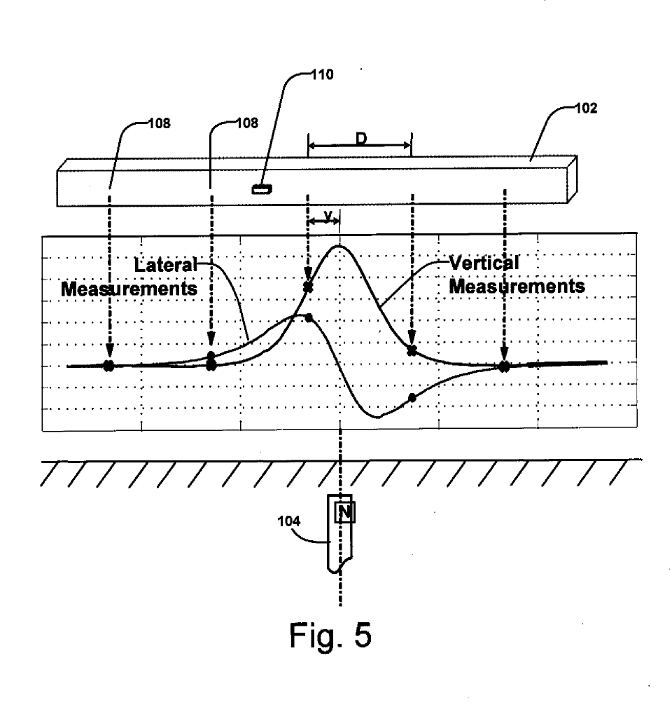

In one embodiment, the two orthogonally positioned probes 120 and 122 in each sensor 108 measure the magnetic field strength in the vertical direction, which is perpendicular to the road surface, and in the lateral direction of the mobile object 106 (e.g., the direction parallel to the vehicle axles). Thus, each sensor 108 has two measurements Bz and By, in the vertical and lateral directions, respectively. FIG. 5 illustrates the lateral and vertical magnetic field strength of a magnet marker 104, and the corresponding measurements of the sensors 108. In this example, the position detection apparatus 102 consists of five sensors 108, which are equally spaced with a sensor spacing of D. The sensor spacing D should be chosen to be smaller than the sensing range of the sensors 108. Exemplary values of D can be 10 cm to 40 cm. The spacing does not need to be equal between the sensors 108. The example shown in FIG. 1, FIG. 2, and FIG. 3 uses equal spacing for D just simply for the convenience of description. For description purpose, the two sensors 108 that are closest to the magnetic marker 104 are identified as the left sensor and the right sensor. The position offset (i.e., the lateral deviation) between the left sensor and the magnetic marker 104 is denoted as y. Based on the illustrated geometric relationship, the lateral measurements and the vertical measurements of each sensor 108 is marked with “” and “x”, respectively.

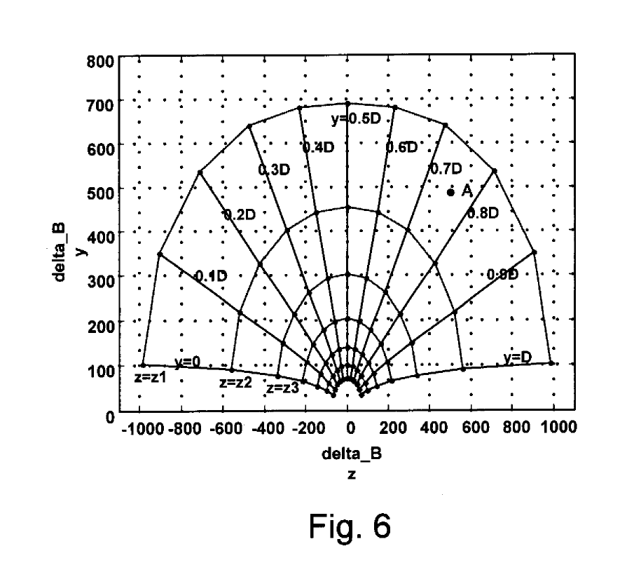

The processor 110 computes the differences in the measurements from the two sensors 108: delta_Bz=(Bzleft−Bzright) and delta_By=(Byleft−Byright), and then determines the lateral deviation based on (delta_Bz, delta_By). In one embodiment, the lateral deviation is determined by mapping the measurement differences into a pre-defined map as shown in FIG. 6.

FIG. 6 is a map illustrating multiple relationships of delta_Bz and delta_y when the sensors 108 are crossing the marker 104 (i.e., the distance from the sensors to the marker 104 is 0 in the longitudinal direction). The x axis and y axis in the Figure corresponds to the values of delta_z and delta_y. Each radiant line represents a relationship between the differences: delta_Bz and delta_By. The values on each radiant line correspond to (delta_y, delta_Bz) at locations with the same lateral deviation and the corresponding lateral deviations (with respect to the left sensor) are marked on each radiant line. Thus, each relationship corresponds to a pre-defined lateral deviation. For example, the relationship represented by the radiant line that is perpendicular to the x axis corresponds to a lateral deviation of D/2 (e.g., D=20 cm). The relationship represented by the radiant line to the furthest left corresponds to a lateral deviation of 0 cm from the left sensor, and the relationship represented by the radiant line to the furthest right corresponds to a lateral deviation of D from the left sensor. The values on each circular line correspond to (delta_By, delta_Bz) at locations with the same height; for example, the outer arc corresponds to a height value of z1; the second arc inward corresponds to a height value of z2 (z2>z1). FIG. 6 shows that delta_By and delta_Bz are almost linear at locations with the same lateral deviation and this linear relationship is insensitive to variations in the lateral deviation and the height.

To describe the position estimation based on the differences in the measurements of the left and right sensors, the computed difference is denoted as (A_delta_By, A_delta_Bz) and its corresponding location is shown as point A in FIG. 6. In one embodiment, the position estimation can first identify the two relationships (i.e., the two radiant lines) point A falls in between. In this example, point A falls in between the radiant lines corresponding to lateral deviations of 0.7D (e.g., 14 cm when D=20 cm) and 0.8D to the left sensor. Thus, point A corresponds to a lateral deviation between 0.7D and 0.8D. By further computing the distances between point A and the two radiant lines, the lateral deviation can be estimated through linear interpolation: y=0.7D+(d1/(d1+d2))*(0.8D−0.7D), where d1 and d2 are the distances from point A to the two radiant lines corresponding to the lateral deviation of 0.7D and 0.8D, respectively.

The above described method of determining the lateral deviation by using the differences between measurements of two of the sensors 108 has the following advantages. First, by computing the differences delta_By and delta_Bz, this method automatically removes the earth field strength in the sensor measurements since the two sensors 108 are close enough to share approximately the same earth field. As the earth field is typically the largest noise source, this method therefore has an advantage over prior art methods. Second, since this method no longer needs to estimate the earth field, it allows the use of variable marker spacing. In some prior art methods, the marker spacing must be greater than a certain distance so that the sensor measurements in the middle of two markers consist mostly of earth field to facilitate the estimation of earth field strength. By eliminating the need of estimating earth field, the present invention allows the markers 104 to be placed more densely to provide more frequent measurement updates when needed. For example, at sharp curves, the vehicle's lateral deviation could change fast and it is a great advantage to vehicle control systems to have frequent position updates that reflect the most recent lateral deviation. Similarly, when approaching a sharp curve, a parking lot, a loading zone, a toll booth, or a station, the vehicle may move slowly and therefore take a longer time to travel the same distance. Denser markers at those locations allow the measurements to be updated often even at low speeds.

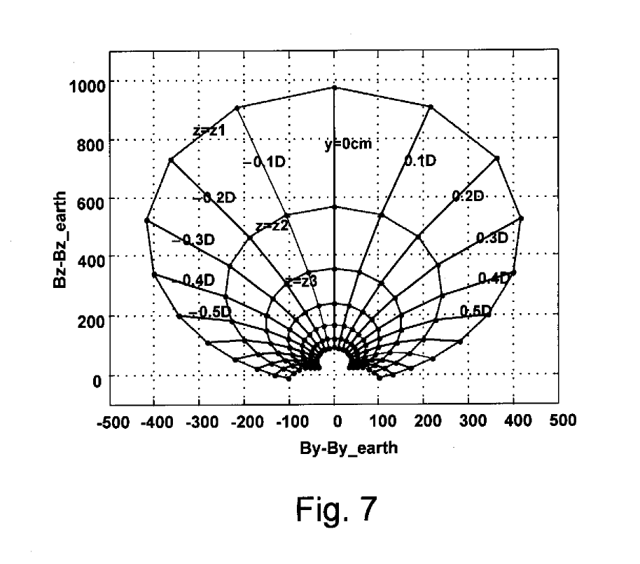

A third advantage comes from the insensitivity of the linear relationship between delta_By and delta_Bz to the variations in both the lateral deviation and the height. As a comparison, FIG. 7 shows the relationship between (By−By_earth) and (Bz−Bz_earth) from a single magnetic field sensor for the same ranges of lateral deviation and height as those in FIG. 6. It is clear that the radiant “lines” become obviously curved when the lateral deviation is greater than 0.2D (i.e., 4 cm when D=20 cm). Moreover, the circular lines get much closer to the center when the lateral deviation becomes larger. Both phenomena indicate that the relationship is sensitive to variations in the lateral deviation and the height. In the real world, the vertical movement of a vehicle due to the spring and road roughness would cause wide variations in the vertical height (z) from the sensor to the marker 104, and the lateral deviation also inevitably varies relatively widely as the vehicle negotiates curves and tries to follow the lane. Therefore, this sensitivity to variations in the lateral deviation and height introduces another significant error in the position estimation for prior art methods that rely on a single sensor. Note that FIG. 7 assumes the earth field has been removed; if not, the earth field becomes another significant noise source that degrades the position estimates.

The insensitivity of the linear relationship between delta_By and delta_Bz to the variations in both the lateral deviation and the height is also an advantage of the present invention over prior art methods that are based on ratios of magnetic field measurements. The relationship between delta_By and delta_Bz is much more linear than the relationship between the relationship of the ratio and the lateral deviation used in the ratio-based prior art methods, even if it is assumed that the ratio is computed with earth field removed.

A fourth advantage comes from the insensitivity of the linear relationship between delta_By and delta_Bz to the variations in the longitudinal distance when the longitudinal distance is relatively small (e.g., x<=L, where L ranges from 20 cm to 40 cm depending on the magnetic marker 104 and operating conditions). This advantage can be easily shown by observing the similar shapes of the delta_By vs. delta_Bz curves for x between −L and L. Such insensitivity allows the position estimation to be conducted as long as the sensors 108 are within a longitudinal range of a marker 104; therefore, the sensor measurements can be used for position estimation when the sensors are within [−L L] distance in the longitudinal direction from the marker 104. In other words, the present invention allows continuous position estimation when the sensors 108 are around a marker 104. As a comparison, prior art methods are often sensitive to the longitudinal distance to the marker 104 and requires the position estimation to be conducted when the sensors are right on top of the marker 104 (i.e., the longitudinal distance x=0). The prior art methods therefore may determine whether the sensors 108 are right on top of the marker 104 by examining whether the vertical magnetic field strength reaches its peak. As a result, only one position estimate is provided per magnetic marker 104. This is especially inadequate when the vehicle is moving slowly and takes a long time to travel from one marker 104 to anther marker 104. The requirement of sufficient marker spacing by prior art methods further worsens the situation. Unlike prior art methods, the present invention allows variable marker spacing and continuous position estimation around markers, where both advantages allow more frequent position estimation updates when necessary.

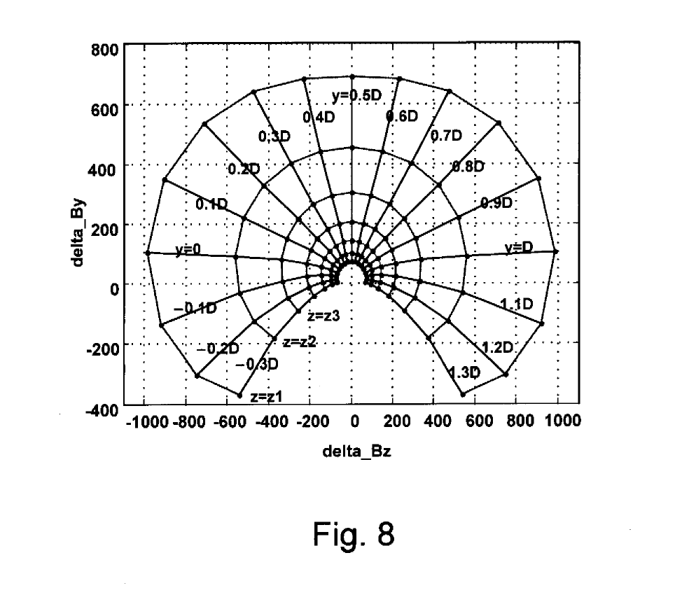

Moreover, although FIG. 6 shows the relationship delta_By and delta_Bz when the marker 104 is in between the two sensors (i.e., y ranging from 0 to D), the linear relationship between delta_By and delta_Bz holds even when the marker 104 is on one side of both of the sensors 108. FIG. 8 shows the relationship of the delta_By and delta_Bz for cases when the magnetic marker 104 is in between the two magnetic field sensors 108 (y=0 to y=D) and when the magnetic marker 104 is on one side of the two sensors 108 (y<0 and y>D). It is clear that the position estimation using (delta_By, delta_Bz) as described earlier applies when the marker 104 is on one side of the two sensors 108 as well.

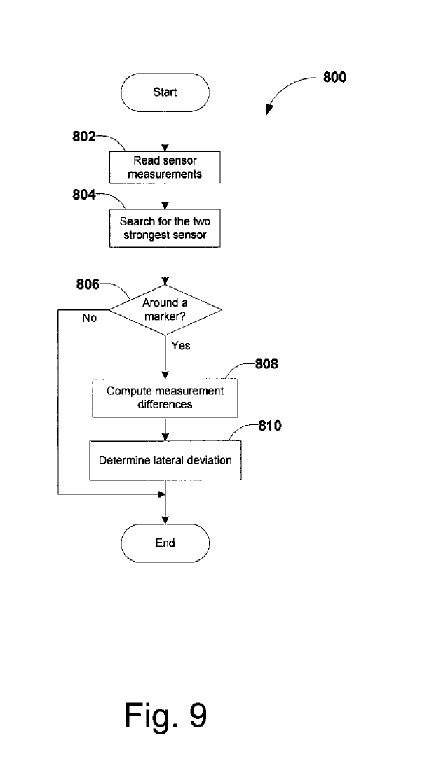

FIG. 9 is a flowchart 900 showing the process for one embodiment of the position detection apparatus 102 for determining the lateral deviation from the apparatus 102 (hence the object where the apparatus is installed on) to the magnetic marker 104. Prior to executing this process, the processor 110 conducts necessary initialization to load the mapping relationship (as shown in FIG. 6) as well as other relevant parameters from the memory and to assign relevant variables to appropriate values. Once the initialization is completed, the processor 110 executes the process in FIG. 9 in each processing cycle. The process starts with reading the magnetic field strength measurements from each sensor 108 in step 902. Based on the sensor measurements, the process searches for the two adjacent sensors that have the strongest measurements of magnetic field strength in the vertical direction in step 904. These two adjacent sensors are the two sensors 108 that are on both sides of the magnetic marker 104. In one embodiment, the process performs step 904 in two sub-steps. The process first searches for the first strongest sensor whose vertical measurement (i.e., the measurement of magnetic field strength in the vertical direction) is the largest among all sensors. The process then compares the vertical measurements of the two sensors 108 adjacent to this first strongest sensor and selects the one that has a larger vertical measurement to be the second strongest sensors. In the case where the strongest sensor is the sensor at the end of the apparatus 102, and therefore only has one adjacent sensor, the process chooses the adjacent sensor as the second strongest sensor. Subsequently in step 906, the process determines whether the strongest sensors are qualified for determining the lateral deviation. In one embodiment, the two strongest sensors are qualified if the following two criteria are met: (1) their vertical measurements are larger than a pre-defined threshold and (2) their lateral measurements have opposite signs. The first criteria is to ensure that the sensors are near a magnetic marker 104 (or in other words, a magnetic marker is nearby), otherwise, the sensors are still far away from a magnetic marker and the measurements' signal-to-noise ratio is too low to provide an accurate position estimation. The second criteria is to ensure the two strongest sensors are on both sides of the magnetic marker 104 (i.e., the magnetic marker is in between the two strongest sensors). If the two strongest sensors are determined to be not qualified, the sensor measurements are discarded and the process exits to wait for the next processing cycle.

Subsequently in step 906, the process then determines whether the strongest sensors are around a magnet marker 104 (i.e., the longitudinal distance from the strongest sensors to the magnetic marker is relatively small). According to the dipole model that mathematically approximates the magnetic field of a magnetic marker 104, for any given lateral deviation and height, the vertical magnetic field strength reaches its maximum value when the longitudinal distance is 0. Therefore, in one embodiment, the process keeps track of Bz_max, which was set to be the magnitude of the vertical measurement when the last strongest sensor was right on top of a marker 104 (i.e., when the longitudinal distance x is approximately 0). In other words, Bz_max was the largest magnitude of the vertical measurement as the last strongest sensor crossed a marker 104. The determination in step 906 is based on whether the vertical measurement of the strongest sensor has a magnitude larger than both a pre-defined threshold and a*Bz_max, where a is a pre-defined ratio (e.g., a value between 0.6 and 1.0). The strongest sensors are around a magnetic marker 104 if the vertical measurement's magnitude is larger than both the pre-defined threshold and a*Bz_max. The purpose of using the pre-defined threshold is to ensure that the sensors are indeed close to a magnetic marker 104 (or in other words, a magnetic marker is nearby). Since in cases when the sensors have been far away from a magnetic marker 104 for some time, Bz of the strongest sensor could remain low, resulting in a small Bz_max. In such cases, a*Bz_max alone would not be sufficient to ensure the sensors are close to a marker 104. By using both a pre-defined threshold and a*Bz_max, the process then ensures the sensors are nearby a marker 104 and the sensor measurements can be used to provide an accurate position estimation.

Alternatively, the dipole model also provides that the longitudinal magnetic field strength crosses zero at the location where the longitudinal distance is 0. Therefore, in another embodiment, the magnetic sensor includes a third probe 120 that senses the longitudinal magnetic field and in step 906 the process determines that the strongest sensors are around a magnetic marker 104 if (1) the longitudinal measurement of the strongest sensor has a magnitude smaller than a pre-defined threshold and (2) the vertical measurement of the strongest sensor has a magnitude larger than another pre-defined threshold. The reason for including the second condition is again to ensure the sensors 108 are close to a magnetic marker 104 since the longitudinal magnetic field could stay small when the sensors are far away from a marker 104.

If the sensors are not around a marker, the process records the current strongest sensors and their measurement values and then exits to wait for the next processing cycle. If the sensors are around a marker 104, the process then continues to step 908 to compute the measurement differences delta_By and delta_Bz using the lateral and vertical measurements of the two strongest sensors. With the measurement differences (delta_By, delta_Bz), the process then determines the lateral deviation in step 910 using the method described earlier with FIG. 6. After step 910, the process then exits to wait for the next processing cycle.

In one embodiment, the processor 110 further averages the lateral deviations estimated around each marker 104 to help reduce the effects of sensor noise. The magnetic markers 104 are placed with fixed or variable distances along the road or path. As the mobile object 106 moves along the road/path, the sensors would be close to a marker 104 for a period of time, away from that marker 104 for a period of time, and then be around to the next marker 104 for a period of time. Since the processing cycle is typically set to run at certain frequencies (e.g., 100 hz), the processor 110 would, in step 906, determine that the sensors are around a marker 104 for several processing cycles, then determines that the sensors are not around a marker 104 for several processing cycles, and then determines that the sensors are around a marker 104 for several processing cycles. Thus, to ensure the processor 110 averages the lateral deviation estimates with respect to the same marker 104, the processor 110 needs to reset the averaging when the sensors are determined to be away from a marker 104. The detailed processing can be as follows. After step 910, the processor 110 computes a summation of the lateral deviation, sum_y, and the number of the lateral deviation, count_y, and then computes the average as ave_=sum_y/count_y when count_y>0. Whenever the processor 110 determines that the sensors 108 are not around a marker 104 in step 906, the processor 110 resets sum_y=0 and count_y=0 before exiting to wait for the next processing cycle. Whenever the processor 110 determines that the sensors are around a marker 104, it adds the lateral deviation (y) to sum_y and increase count_y by 1: sum_y=sum_y+y, and count_y=count_y+1, and then computes ave_y=sum_y/count_y. Thus, the lateral deviation estimates corresponding to the same marker 104 are averaged. The processor 110 then reports the averaged lateral deviation before it exits to wait for the next processing cycle.

In further embodiments, the processor 110 may also compare the current lateral deviation estimate with the averaged lateral deviation that corresponds to the same magnetic marker 104 and determines whether the current lateral deviation estimate is trustworthy. If the difference between the current lateral deviation and the averaged lateral deviation is small than a pre-defined threshold, the current lateral deviation estimate is regarded as trustworthy and it is added to the summation to generate a new averaged lateral deviation. If the difference is larger than the pre-defined threshold, it is regarded as not trustworthy and discarded; thus, the averaged lateral deviation remains unchanged. The advantage of this embodiment is that it further helps in rejecting large noises or disturbances in measurements.

In another embodiment, the processor 110 further determines the polarity of the magnetic marker 104 based on the direction of the vertical magnetic field measurement. As the magnetic field strength vector points from the south pole to the north pole of the magnetic marker 104. Therefore, when the magnetic marker 104 is installed with its north pole facing upward, the magnetic field strength measured by the vertical probe 120 of the sensors 108 points down towards the ground. When the magnetic marker 104 is installed with its south pole facing upward, the magnetic field strength measured by the vertical probe 120 of the sensors 108 points upward from the ground. As a result, the vertical measurements have either positive or negative signs depending on the orientation of the marker 104. Accordingly, the processor 110 can use this information from the vertical measurements (e.g., from the strongest sensor) to determine the polarity of the upward side of the magnetic marker 104. The processor 110 may further output the polarity information together with the lateral deviation.

In one further embodiment, the magnetic markers 104 are installed with pre-arranged sequences of the orientation to form various codes and the processor 110 further decodes the sequence of marker polarity. As a magnetic marker 104 is either installed with either its north pole or its south pole facing upward, each constitutes one bit (1 or 0) in a binary code. For example, if north is treated as 1, then the code 1100101 can be implemented with 7 consecutive magnetic markers 104 that are installed with the following sequence of polarity facing upward: north, north, south, south, north, south, and north, respectively for each marker 104. After the processor 110 determines the polarity for a marker 104, it records the polarity in the polarity queue and examine whether the polarity sequence of the last N markers 104 forms a pre-defined code. Various methods can be used for the decoding, such as directly comparing the sequence with the pre-defined codes or using code forming computations such as hamming codes. The processor 110 may further output the code for other systems to use.

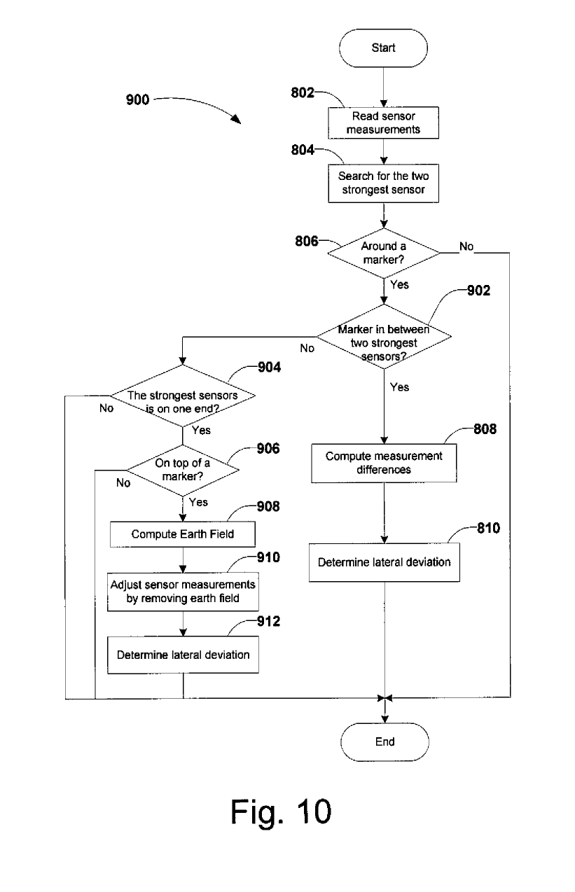

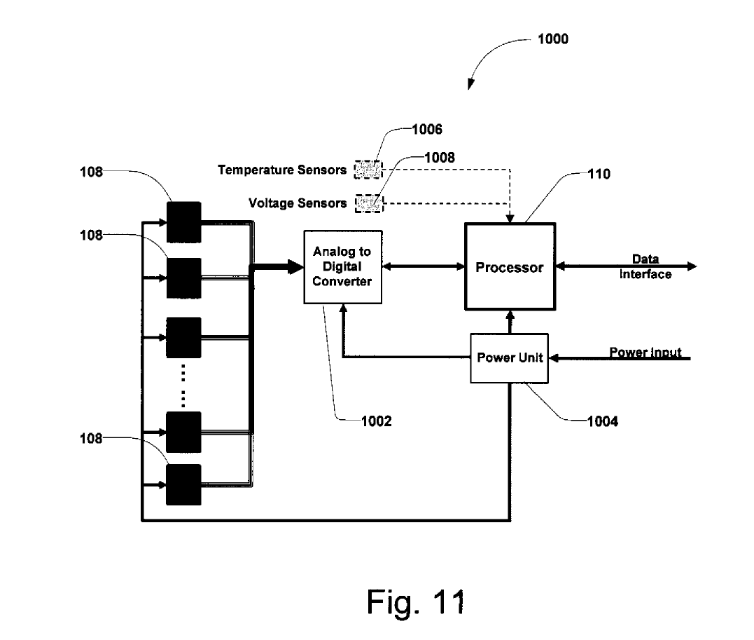

Note that in the process in FIG. 9 the magnetic marker 104 is in between the two strongest sensors if it is between the most left sensor and the most right sensor. However, when a magnetic marker 104 is to the left (or right) of the apparatus 102, the strongest sensor is the magnetic field sensor 108 at the left (or right) end of the apparatus and the second strongest sensor would be its only adjacent sensor, the one to its right (or left). In both cases, the magnetic marker 104 is on one side of both sensors. As shown in FIG. 8, the linear relationship between delta_By and delta_Bz still holds when the marker 104 is on one side of both sensors; however, the linearity gets less perfect as the marker 104 gets further away from both sensors. Alternatively, another embodiment as described below with FIG. 10 may be used.

FIG. 10 is a flow chart diagram 1000 for another embodiment of the process employed by the processor 110 to determine the lateral deviation. In this embodiment, the process also has steps 902, 904, and 906. If the two strongest sensors are determined to be around a marker 104 in step 906, the process then further determines whether the magnetic marker 104 is in between the two strongest sensors in step 1002. Since the lateral magnetic field strength to the left of a magnetic marker 104 and that to the right has opposite signs, the marker 104 is in between the two sensors if the lateral measurements from the two strongest sensors have opposite signs. Thus, the process examines the signs of the two lateral measurements to make its decision in step 1002. If the marker 104 is in between the two sensors, the process continues to steps 908 and 910 as described with FIG. 9.

If in step 1002 the process determines the marker 104 is on one side of both sensors, the process goes to step 1004 to check if the strongest sensor is on one end of the apparatus 102. Each sensor can have a sequence number (e.g., numbered as sensor 1 to sensor N from one end to the other) and the strongest sensor is an end sensor if it is sensor 1 or sensor N. If the strongest sensor is not an end sensor, the measurements must be abnormal (which is typically rare) and the process discards the measurements and exits to wait for the next processing cycle.

If the strongest sensor is an end sensor, the process continues to step 1006 to determine whether the sensor 108 is on top of the magnetic marker 104. Note that since the position estimation based on one sensor's measurement is more sensitive to the longitudinal distance from the sensor to the marker 104, it is preferred to have the sensor right on top of the marker (i.e., the longitudinal distance x is 0) when only one sensor is used for position estimation. The process can track the vertical measurement of the strongest sensor to detect whether its magnitude has reached its peak in magnitude. Once the vertical measurement magnitude reaches its peak, the process detects that the strongest sensor is right on top of the marker 104 and continues to the subsequent step 1008. If not, the process exits and waits for the next processing cycle.

In step 1008 the process estimates the earth field strength and in step 1010 it removes the earth field strength from the sensor measurements. Step 1008 and step 1010 are necessary since in this case measurements from one sensor (i.e., the strongest sensor) instead of two sensors are now used to determine the lateral deviation. With multiple sensors 108 in the apparatus 102, the earth field strength can be estimated using measurements from sensors that are away from the strongest sensor. Those sensors are far away from the magnetic marker 104 and therefore their measurements consist almost entirely of the earth field strength. In one embodiment, the earth field can be estimated by averaging the measurements from the sensors away from the strongest sensor. Accordingly, in step 1010, (By_strongest−By_earth) and (Bz_strongest−Bz_earth) are computed to remove the earth field strength from the measurements of the strongest sensor.

Subsequently in step 1012, (By_strongest−By_earth) and (Bz_strongest−Bz_earth) are used to estimate the lateral deviation by mapping these values to the map shown in FIG. 7. Afterwards, the process exits to wait for the next processing cycle.

FIG. 11 is a block diagram of another embodiment of a position detection apparatus 1100, where in addition to the sensors 108 and the processor 110, the apparatus 1100 further includes an analog-to-digital converter 1102 and a power unit 1104. The analog-to-digital converter 1102 is necessary when the sensors 108 output their measurements as analog signals instead of digital signals and the processor 110 does not have analog-to-digital conversion capability. Depending on the power source used to provide the power input to the apparatus 1100, a power unit 1104 may be needed to stabilizes the power and to amplify it according to the needs of the sensors 108 and the processor 110. In addition, other sensors may also be included. For example, a temperature sensor 1106 may be included to measure the ambient temperature and the processor 110 can further use the temperature information to compensate the temperature-induced drifts or other effects in sensor measurements. Similarly, voltage sensors 1108 may be included to monitor the power voltage and therefore allows the processor 110 to compensate the measurement drifts or other effects due to variations in power.

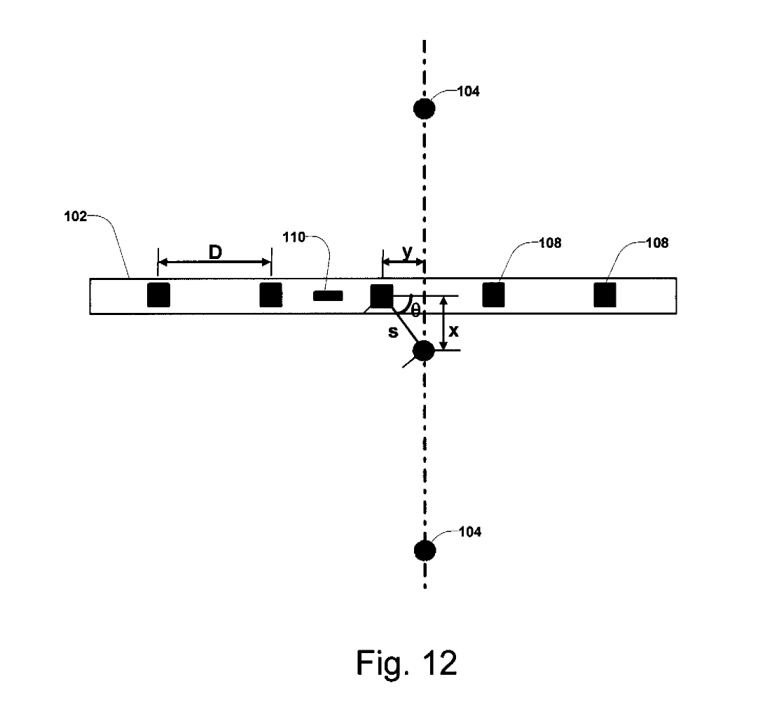

FIG. 12 illustrates another embodiment of the method and apparatus for detecting the position of a mobile object on which the apparatus 102 is installed. In this embodiment, each magnetic field sensor 108 includes three orthogonally oriented probes measuring the magnetic field strength in the vertical, lateral, and longitudinal directions. In this embodiment, the lateral deviation is determined based on the three measurements (from the three probes) of the strongest sensor (i.e., the magnetic field sensor whose vertical measurement is the strongest in magnitude). To take advantage of the longitudinal measurements, this method estimates the Euclidean distance s (s=sqrt(x²+y²)) from the strongest sensor to the magnetic marker 104 on the x-y plane and then computes the lateral deviation y. By viewing the relationship through the vertical plane the strongest sensor and the magnetic marker 104 are both on, the strongest sensor is equivalent to being on top of the marker 104 if the distance s is treated as the “lateral” deviation. In other words, if s is estimated (instead of x), the strongest sensor is always right on top of the sensor regardless of the value of the longitudinal distance x. Thus, the measurements from the lateral probe can be combined and the longitudinal probe to compute their Euclidean norm Bs: Bs=sqrt((Bx−Bx_earth)²+(By−By_earth)²), where Bx_earth and By_earth can be estimated from the measurements of a sensor (or multiple sensors) away from the strongest sensor. The relationship between Bs and (Bz−Bz_earth) is almost linear, similar to the map shown in FIG. 7. Therefore, by mapping the value of (Bs, (Bz−Bz_earth)) against a pre-defined map, an estimate of the distance s can be obtained. The next step is to compute the lateral deviation x.

As described earlier, according to the dipole model, the magnetic field strength at a location P(x,y,z) with respect to the magnetic marker 104 is given by B=(μ₀M/4πr⁵){3xzi+3yzj+(2z²−x²−y²)k}, where r is the distance between P and the magnetic marker 104, μ₀ is a constant representing the permeability of free space, and M is the magnetic moment of the marker 104 and varies according to marker material. xi corresponds to the direction of travel, yj corresponds to the lateral deviation, and zk is the height relative to the marker's center. Thus, the adjusted lateral measurement (By−By_earth)=(μ₀M/4πr⁵){3yzj} and the adjusted longitudinal measurement (By−By_earth)=(μ₀M/4πr⁵){3xzj}. Thus, the Euclidean norm of (By−By_earth) and (Bx−Bx_earth), Bs, has a value of (μ₀M/4πr⁵){3sz}. Accordingly, the lateral deviation y and the longitudinal distance x can be estimated as the follows: y=s*((By−By_earth)/Bs) and x=s*((Bx−Bx_earth)/Bs).

This method would be sensitive for cases when the Euclidean norm Bs is very small. In such cases, both (By−By_earth) and (Bx−Bx_earth) must be small, indicating both x and y are close to zero. The lateral deviation can be directly approximated by the distance s, which is already close to zero. Alternatively, since in such case, the longitudinal distance x is small and the sensor 108 is essentially right on top of the marker 104, the lateral deviation can be directly estimated using the lateral and vertical measurements instead.

The embodiment described above together with FIG. 12 has the following advantages. First, it does not require estimation of earth field by using the measurements in between two magnetic markers 104; instead, it uses the measurements of the sensors 108 that are away from the strongest sensor to estimate the earth field. Therefore, it also allows various marker spacing as well as denser marker at certain locations such as sharp curves or near stations. Second, it no longer requires the sensors to be on top of a marker 104 or close to the marker 104 in the longitudinal direction to conduct position estimation. On the contrary, it allows continuous position detection in a wide range of longitudinal distance from the marker 104 by employing the measurements of the longitudinal field strength.

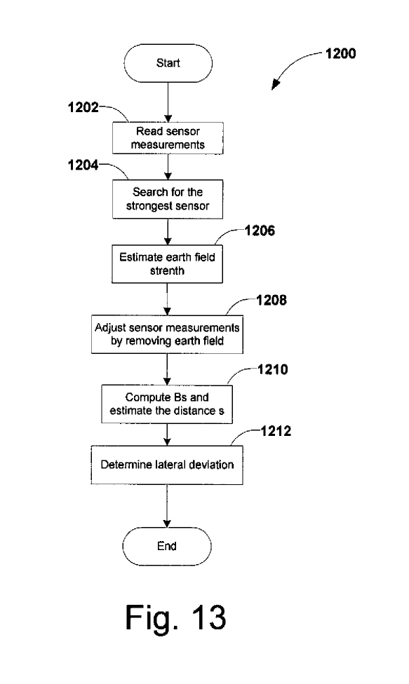

FIG. 13 is a flowchart 1300 showing the process involved in one embodiment of the position detection apparatus 102 for determining the lateral deviation from the apparatus 102 (hence the object where the apparatus is installed on) to the magnetic marker 104 using magnetic field strength measurements in the vertical, lateral, and longitudinal direction. In each processing cycle, the process starts with reading the measurements from all the sensors 108 in step 1302. The process then searches for the strongest sensor based on the vertical measurements in step 1304; the sensor 108 whose vertical measurement has the largest magnitude is the strongest sensor. In one embodiment, the process may also require the vertical measurement of the strongest sensor to be larger than a pre-defined threshold in the search to only process the data when the signal-to-noise ratio is relatively large.

In step 1306, the process estimates the earth field strength based on measurements from the sensors 108 that are away from the strongest sensor. In one embodiment, the earth field strength may be estimated by averaging the measurements of those other sensors in each of the three directions. In step 1308, the process removes the earth field strength from the measurements of the strongest sensor. In other words, the process computes (Bx−Bx_earth), (By−By_earth), and (Bz−Bz_earth). Subsequently in step 1310, the process computes the Euclidean norm Bs=sqrt((Bx−Bx_earth)²+(By−By_earth)²) and estimates the Euclidean distance s based on Bs and (Bz−Bz_earth) (e.g., by mapping Bs and (Bz−Bz_earth) to a pre-defined table). Finally in step 1312, the process determines the lateral deviation y based on s, Bs, and (By−By_earth) as described earlier together with FIG. 12. In one embodiment, the process may estimate the longitudinal distance x as well as the angel θ based on x and y. The process then exits to wait for the next processing cycle.

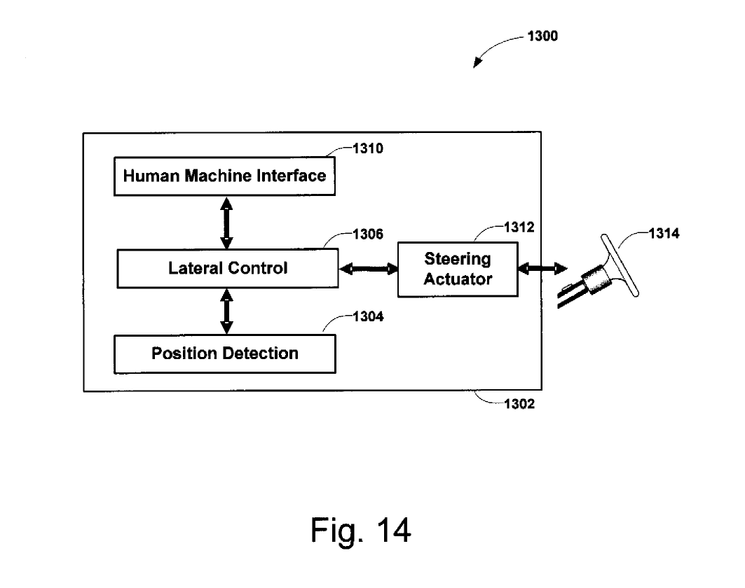

FIG. 14 is a block diagram 1400 of an embodiment for an intelligent lateral guidance system 1402 using the position detection method and apparatus. The intelligent lateral guidance system 1402 is capable of guiding the mobile object 106 such as a road vehicle through a path defined by the magnetic markers 104. The magnetic markers 104 may be installed along the centerline of a path or with an offset to the road centerline. The position sensing unit 1404 includes the position detection apparatus 102 as described with reference to FIG. 1 through FIG. 13 to determine the lateral deviation of the mobile object 106 with respect to the magnetic markers 104 along the path or roadway. The position detection apparatus 102 may also provide the polarity of the markers 104 and the code information.

A lateral control unit 1406 computes the desired steering angle that is needed to ensure the mobile object 106 follows the path based on the lateral deviation from the position sensing unit 1404. The lateral control unit 1406 may also utilize the code information to infer the road curvature, the travel distance along the path, as well as other information pre-stored in code tables. Various control techniques can be used to determine the desired steering angle based on the lateral deviation and other available information. Those control techniques are well-known to those skilled in the art and therefore are not described here. A steering actuator unit 1412 consists of a motor (not shown) that can turn a steering wheel 1414, and upon receiving the desired steering angle from the lateral control unit 1406, the motor turns the steering wheel 1414 to the desired steering angle. In one embodiment, the steering actuator unit 1412 may also consists of a servo control processor (not shown) as well as relevant sensors that measure the steering wheel angle. The servo control processor further determines the angle the motor should turn the wheel 1414 to (or the torque the motor should exert onto the steering wheel 1414) based on the desired steering angle from the lateral control unit 1406.

In one embodiment, the intelligent lateral control system 1402 further includes a human machine interface (HMI) unit 1410. The HMI unit 1410 provides information to and receives commands from the operator of the mobile object 106 (or the monitoring personnel); it also receives system operating status from and sends the operator's commands to the lateral control unit 1406. In one embodiment, the HMI unit 1410 further monitors the integrity of the information and system operation. The HMI unit 1410 consists of audio and visual feedback to the operator as well as switches and panels that can be operated by the operator.

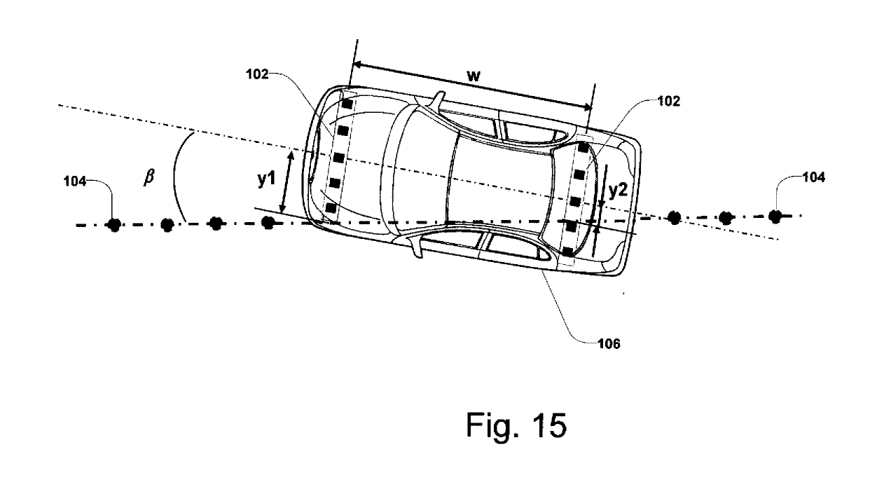

In another embodiment, the position sensing unit 1404 consists of more than one position detection apparatus 102. For example, two position detection apparatuses 102 can be used, one installed at the front of the mobile object 106 and the other at the middle (or rear) of the mobile object 106. FIG. 15 illustrates the location of the two position detection apparatuses 102. Each position detection apparatus 102 provides a lateral deviation of the mobile object 106 with respect to the magnetic markers 104. Thus, the lateral control unit 1406 receives two lateral deviations, y1 at the front of the mobile object 106 and y2 at the middle (or rear) of the mobile object 106. The lateral control unit 1406 further determines a relative angle β (i.e., the angle of the mobile object with respect to the path or roadway) as:) β=atan((y1−y2)/w), where w is the distance between the two position detection apparatuses 102. The lateral control unit 1406 then uses both the two lateral deviations and the relative angle to determine the desired steering angle.

Although the present invention has been described above with particularity, this was merely to teach one of ordinary skill in the art how to make and use the invention. Many additional modifications will fall within the scope of the invention, as that scope is defined by the following claims.

What is claimed is:

1. A method for determining a position deviation of an object relative to at least one magnetic marker, comprising:
sensing, with at least two sensors mounted on the object, at least two axial field strength components of a magnetic field emitted from the magnetic marker with each of the sensors;
computing a difference of the field strength components from two sensors for each of two axial directions; and
determining the position deviation of the object from the magnetic marker as a function of the differences.

2. The method of claim 1, wherein the at least two sensors mounted on the object are aligned in a lateral direction of the object, the two axial field strength components are in lateral and vertical directions of the object, and the position deviation of the object is a deviation in the lateral direction.

3. The method of claim 1, wherein the magnetic marker is one of multiple magnetic markers that are installed in a predetermined path the object travels along and the position deviation of the object is a lateral deviation from the predetermined path.

4. The method of claim 1 further comprising at least one pre-defined map associating the differences with the position deviation, wherein the method determines the position deviation of the object by mapping the differences into the pre-defined map.

5. The method of claim 4, wherein:
the pre-defined map consists of multiple relationships between the differences in the two axial directions, wherein each relationship corresponds to a pre-defined lateral deviation;
mapping the differences includes first identifying two relationships the differences fall in between, obtaining two pre-defined lateral deviations corresponding to the two identified relationships, and computing two distances from the differences to the two relationships; and
the method determines the position deviation by interpolating between the two pre-defined lateral deviations with the two distances.

6. The method of claim 1, wherein each sensor comprises a digital two-axis magnetic field sensor providing magnetic field strength measurements in digital form for the two axial directions.

7. The method of claim 1, wherein the sensors output the field strength measurements to a digital processor and the digital processor processes the measurements to obtain the position deviation.

8. The method of claim 1, wherein:
each sensor comprises an analog two-axis magnetic field sensor providing magnetic field strength measurements in analog form for the two axial directions,
the sensors output the said field strength measurements to at least one analog-to-digital converter and the analog-to-digital converter converts the field strength measurements from analog form to digital form, and
the analog-to-digital converter outputs the converted field strength measurements in digital form to a digital processor and the digital processor processes the converted measurements to obtain the position deviation.

9. The method of claim 1, wherein more than two sensors are mounted on the object, said method further comprising selecting two strongest sensors among the sensors, computing the differences in the field strength components sensed by these two strongest sensors, and determining the position deviation of the object based on the differences.

10. The method of claim 9, wherein the two axial field strength components are in lateral and vertical directions of the object, and the two strongest sensors are selected by:
finding a first strongest sensor whose sensed vertical field strength component is largest in magnitude among the sensors, and
comparing the vertical field strength component sensed by sensors adjacent to the first strongest sensor and selecting the adjacent sensor that sensed a larger vertical field strength component as a second strongest sensor.

11. The method of claim 1 further determining the polarity of the magnetic marker based on direction of the field strength components.

12. A method for determining a position deviation of a mobile object relative to a magnetic marker, comprising:
sensing three axial field strength components of a magnetic field emitted from the magnetic marker;
computing a second-order Euclidean norm of two axial field components;
determining a Euclidean distance from the object to the magnetic marker based on the Euclidean norm and a third axial field strength component, wherein the Euclidean distance is in a plane defined by the two axial directions; and
determining the position deviation of the object from the magnetic marker as a function of the Euclidean distance, the Euclidean norm, and the two axial field components.

13. The method of claim 12 further comprising a pre-defined map associating the Euclidean norm and the third axial field strength component with the Euclidean distance, wherein the Euclidean distance is determined by mapping the Euclidean norm and the third axial field strength component into the pre- defined map.

14. The method of claim 13, wherein:
the pre-defined map consists of multiple relationships between the Euclidean norm and the third axial field strength component, where each relationship corresponds to a pre-defined Euclidean distance;
the mapping comprises identifying two relationships that the Euclidean norm and the measured third axial field strength component fall in between, obtaining two pre-defined Euclidean distances corresponding to the two identified relationships, computing two distances from the Euclidean norm and the third axial field strength component to the two relationships, and
the method determines the position deviation by interpolating between the two pre-defined Euclidean distance using the two distances.

15. The method of claim 12, wherein the three axial field strength components are in a lateral, longitudinal, and vertical direction of the object, the two axial field strength components are in the lateral and the longitudinal directions, the third axial field strength component is in the vertical direction, and the position deviation of the object is a lateral deviation from the magnetic marker.

16. The method of claim 15, wherein at least two sensors are mounted on the mobile object, further comprising:
finding a strongest sensor whose sensed field strength component in the vertical direction is largest in magnitude among the sensors;
estimating earth magnetic field strength using the sensed field strength components of at least one sensor other than the strongest sensor;
adjusting the sensed field strength components of the strongest sensor by removing the estimated earth magnetic field strength; and
determining the position deviation of the mobile object based on the adjusted field strength components of the strongest sensor.

17. The method of claim 15, wherein the method further determines the position deviation from the object to the magnetic marker in the longitudinal direction as a function of the Euclidean distance, the Euclidean norm, and the two axial field components.

18. An intelligent lateral control system installed on a mobile object including a steering wheel for controlling the mobile object to follow a path embedded with magnetic markers, comprising:
a position sensing unit to provide at least one position deviation of the mobile object with respect to the magnetic markers by processing differences in measurements of two sensors;
a lateral control unit to determine a desired steering angle based on the position deviation from the position sensing unit; and
a steering actuator unit to turn the steering wheel based on the desired steering angle;

19. The system of claim 18 further comprising a human machine interface unit to receive commands from an operator, provide the commands from the operator to the lateral control unit, receive system information from the lateral control unit, and display the received system information to the operator.

20. The system of claim 18, wherein the position sensing unit comprises at least one position detection apparatus, each position detection apparatus comprising:
at least two sensors, each sensing at least two axial field strength components of a magnetic field emitted from a magnetic marker; and
a processor receiving magnetic field strength measurements from each sensor and determining a position deviation using differences in field strength measurements from two sensors.

21. The system of claim 20, wherein the processor determines the position deviation by identifying two strongest sensors among the sensors, computing differences of the field strength measurements from the two strongest sensors, and determining a position deviation of the object as a function of the differences.

22. The system of claim 20, wherein the position detection apparatus further comprises at least one analog to digital converter to receive the magnetic field strength measurements in analog form from each sensor, convert the magnetic field strength measurements from analog form to digital form, and provide the magnetic field strength measurements in the digital form to the processor.

23. The system of claim 18, wherein:
the position sensing unit provides at least two position deviations of the mobile object with respect to the magnetic markers;
the lateral control unit computes a relative angle of the mobile object with respect to the path based on the at least two position deviations; and
the lateral control unit determines the desired steering angle based on the position deviations and the relative angle.
